(19) United States
(12) Patent Application Publication
(10) Pub. No.: US 2018/0373198 A1
(43) Pub. Date: Dec. 27, 2018

(54) PROCESS CARTRIDGE AND IMAGE FORMING APPARATUS

(71) Applicants: Hiroshi Mizusawa, Tokyo (JP); Hiroshi Nakai, Kanagawa (JP); Hisashi Kikuchi, Kanagawa (JP); Kazuhiko Watanabe, Tokyo (JP); Sho Akiyama, Tokyo (JP); Tomoyuki Kirigane, Kanagawa (JP); Kenji Komito, Tokyo (JP)

(72) Inventors: Hiroshi Mizusawa, Tokyo (JP); Hiroshi Nakai, Kanagawa (JP); Hisashi Kikuchi, Kanagawa (JP); Kazuhiko Watanabe, Tokyo (JP); Sho Akiyama, Tokyo (JP); Tomoyuki Kirigane, Kanagawa (JP); Kenji Komito, Tokyo (JP)

(21) Appl. No.: 16/018,657

(22) Filed: Jun. 26, 2018

(30) Foreign Application Priority Data
Jun. 26, 2017 (JP) 2017-124146
Apr. 24, 2018 (JP) 2018-082804

(51) Int. Cl. G03G 21/18; G03G 21/00

(52) U.S. Cl. CPC G03G 21/1814; H04N 1/00909; G03G 21/0094

(57) ABSTRACT

A process cartridge includes an image bearer to bear a toner image, a lubricant supply device to supply a lubricant to the surface of the image bearer, and a blade made of elastic material, with the leading end abutting the surface of the image bearer, wherein the leading end is formed to have an elasticity power of from 65 to 93 percent, wherein the process cartridge is detachably attachable to an image forming apparatus.

### CROSS-REFERENCE TO RELATED APPLICATIONS

This patent application is based on and claims priority pursuant to 35 U.S.C. § 119 to Japanese Patent Application Nos. 2017-124146 and 2018-082804, filed on Jun. 26, 2017 and Apr. 24, 2018, respectively, in the Japan Patent Office, the entire disclosures of which are hereby incorporated by reference herein.

### BACKGROUND

### Technical Field

The present disclosure relates to a process cartridge and an image forming apparatus.

### Description of the Related Art

A technology has been widely known which installs a lubricant supply device in an image forming apparatus such as a photocopier and a printer to supply a lubricant to the surface of an image bearer such as a drum photoconductor and an intermediate transfer belt to reduce abrasion and chipping-off of a cleaning blade (blade) abutting the image bearer, degradation of the image bearer, defective cleaning over time, and occurrence of filming on the surface of the image bearer.

More specifically, the lubricant supply device includes a lubricant supply roller which slidably abuts the image bearer, a solid lubricant which slidably abuts the lubricant supply roller, a pressure assembly (biasing member) which biases the solid lubricant toward the lubricant supply roller, etc. The lubricant is gradually scraped from the solid lubricant by the lubricant supply roller that rotates in a particular direction. The lubricant scraped off by the lubricant supply roller is coated on (supplied to) the surface of the image bearer.

On the other hand, a technology has been proposed which sets an elasticity power of the front ridge portion of a cleaning blade of from 50 to 80 to prevent the cleaning blade from turning inward or outward and reduce abrasion, abnormal noise, and defective cleaning particularly in an image forming apparatus including no lubricant supply device.

In addition, another technology has been proposed which sets an elasticity power of the edge layer of a cleaning blade of 40 percent or higher to prevent degradation of the cleaning blade over time.

In a typical image forming apparatus, in some occasions, a lubricant is excessively or unevenly supplied (applied) to the surface of an image bearer over time.

Such drawbacks shorten the working life of a lubricant supply device or cause production of defective images.

### SUMMARY

According to the present invention, provided is an improved process cartridge which includes an image bearer to bear a toner image, a lubricant supply device to supply a lubricant to the surface of the image bearer, and a blade made of elastic material, with the leading end abutting the surface of the image bearer, wherein the leading end is formed to have an elasticity power of from 65 to 93 percent, wherein the process cartridge is detachably attachable to an image forming apparatus.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating the entire of the image forming apparatus according to an embodiment of the present disclosure;

FIG. 2 is a configuration of an image forming unit;

FIG. 3 is a diagram illustrating a perspective view of a lubricant supply device;

FIG. 4 is a diagram illustrating an enlarged view of a cleaning blade abutting a drum photoconductor;

FIG. 5 is a diagram illustrating a state in which elasticity power of the cleaning blade is being measured;

FIG. 6 is a table illustrating blade properties and experiment results of Examples 1 to 7 and Comparative Examples 1 to 3, which are described later;

FIGS. 7A and 7B are graphs illustrating relations between the traveling distance of the drum photoconductor and the consumption rate of the lubricant of Examples 1 to 7 and Comparative Examples 1 to 3, which are described later;

FIG. 8 is a graph illustrating the rating of uneven application of the lubricant of Examples 1 to 7 and Comparative Examples 1 to 3, which are described later;

FIG. 9 is a graph illustrating the abrasion area of the leading end of the cleaning blade of Examples 1 to 7 and Comparative Examples 1 to 3, which are described later; and

FIG. 10 is a schematic diagram illustrating a state of abraded leading end of the cleaning blade.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Moreover, image forming, recording, printing, modeling, etc. in the present disclosure represent the same meaning, unless otherwise specified.

Next, embodiments of the present disclosure are described in detail with reference to the accompanying drawings. In each drawing, the same symbol is assigned to identical or corresponding parts and the description thereof is not repeated but suitably simplified or omitted.

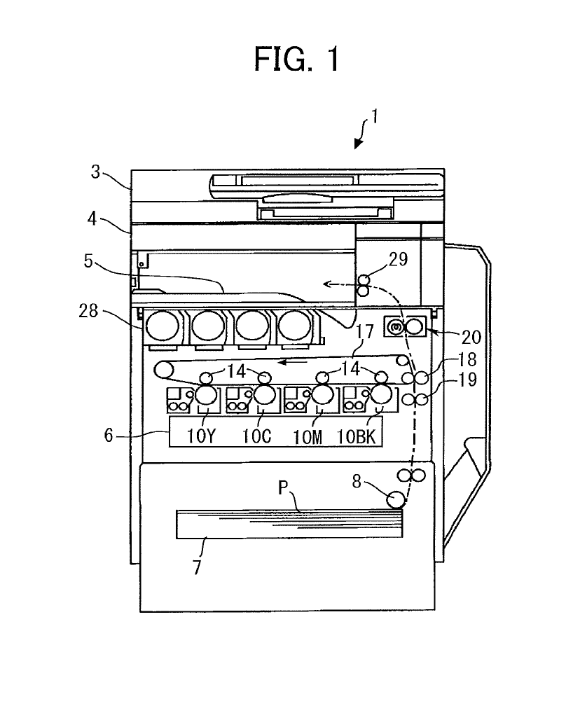

First, the entire configuration and behavior of an image forming apparatus with reference to FIG. 1.

The image forming apparatus (color) 1 according to an embodiment of the present disclosure is a tandem type including multiple process cartridges 10Y, 10M, 10C, and 10Bk as image forming units facing an intermediate transfer belt 17.

The image forming apparatus (color photocopier) 1 includes an original conveying unit 3 to convey an original (document) to an original scanning unit 4 to read image information of the original, a writing unit (irradiation unit) 6 to emit laser beams according to the input image information, and a sheet feeder unit 7 where a sheet P such as transfer sheet is accommodated.

In addition, the process cartridges 10Y, 10M, 10C, and 10Bk respectively correspond to each color of yellow, magenta, cyan, and black as image forming units. The image forming apparatus 1 further includes an intermediate transfer belt 17 where multiple color toner images are transferred and overlapped, and a secondary transfer roller 18 to transfer the toner image formed on the intermediate transfer belt 17 to the sheet P.

In addition, the image forming apparatus 1 furthermore includes a fixing device 20 to fix an unfixed image on the sheet P and a toner container 28 to replenish each color toner to each developing unit of each of the process cartridges (image forming units) 10Y, 10M, 10C, and 10Bk.

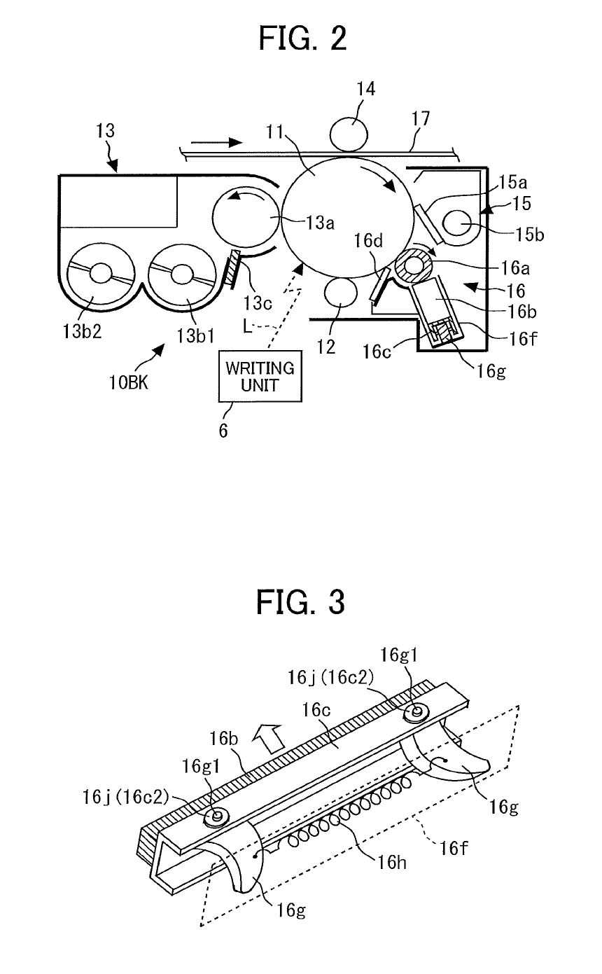

Each of the process cartridges (image forming units) 10Y, 10M, 10C, and 10Bk integrally includes a drum photoconductor 11 as an image bearer, a charging roller 12 as a charging device, a developing device 13, a cleaning device 15, and a lubricant supply device 16 (FIG. 2). Each of the process cartridges (image forming units) 10Y, 10M, 10C, and 10Bk is replaced in the image forming apparatus 1 when its working life elapses.

Toner images of each color (yellow, magenta, cyan, and black) are formed on the drum photoconductor (image bearer) 11 in each of the process cartridges (image forming units) 10Y, 10M, 10C, and 10Bk.

Below is a description about the behavior during typical color image forming in the image forming apparatus 1.

First, a conveying roller of the original conveying unit 3 conveys an original from a platen to a contact glass of the original scanning unit 4. The original scanning unit 4 optically scans the original placed on the contact glass to obtain the image information of the original.

More specifically, the original scanning unit 4 scans the image of the original on the contact glass with light emitted from an irradiation lamp. The light reflected at the original is focused at a color sensor via a group of mirrors and lenses. After each color separation light of red, green blue (RGB) of the color image information of the original is read at the color sensor, the color image information of the original is converted into electric image signals. Furthermore, based on the color separation image signals of RGB, the signals are subject to color conversion, color calibration, spatial frequency correction, etc., at the image processing unit to obtain the color image information of yellow, magenta, cyan, and black.

The image information of each color of yellow, magenta, cyan, and black is transmitted to the writing unit 6. The writing unit 6 emits a laser beam (irradiation light) L based on the image information of each color to the corresponding drum photoconductors 11 of the corresponding process cartridges 10Y, 10M, 10C, and 10Bk.

The four drum photoconductors 11 separately rotate clockwise in the drawing. The surface of the drum photoconductor 11 is uniformly charged at the position facing the charging roller 12 (charging process). The charging bias is thus formed on the drum photoconductor 11. Thereafter, the surface of the charged drum photoconductor 11 reaches the irradiation position of respective laser beams.

The writing unit 6 emits laser beams L corresponding to the image signal from the light source for each color. The laser beams enter and reflect at a polygon mirror and thereafter transmits multiple lenses. The laser beams after transmission of the multiple lenses travel through separate optical paths for each color component of yellow, magenta, cyan, and black (irradiation process).

The surface of the drum photoconductor 11 of the process cartridge 10Y situated leftmost on the drawing is irradiated with the laser beams corresponding to the yellow component. The laser beams of the yellow component scan the drum photoconductor 11 along the rotation axis direction (main scanning direction) thereof by a polygon mirror rotating at high speed. Consequently, a latent electrostatic image corresponding to the yellow component is formed on the drum photoconductor 11 that has been charged by the charging roller 12.

Similarly, the surface of the drum photoconductor 11 of the process cartridge 10C disposed second leftmost on the drawing is irradiated with the laser beams corresponding to the cyan component to form a latent electrostatic image of the cyan component. Similarly, the surface of the drum photoconductor 11 of the process cartridge 10M disposed third leftmost on the drawing is irradiated with the laser beams corresponding to the magenta component to form a latent electrostatic image of the magenta component. The surface of the drum photoconductor 11 of the process cartridge 10K disposed fourth leftmost (furthermost downstream in the direction of movement of the intermediate transfer belt 17) on the drawing is irradiated with the laser beams corresponding to the black component to form a latent electrostatic image of the black component.

Thereafter, the surface of the drum photoconductor 11 on which the latent electrostatic image of each color is formed separately reaches the position facing the developing device 13 (developing roller 13a). Thereafter, the toner of each color is supplied from each developing device 13 onto the drum photoconductor 11 to develop the latent image on the drum photoconductor 11 (developing process).

Thereafter, the surface of the drum photoconductor 11 after the developing process reaches the position opposing the intermediate transfer belt 17. At each opposing position, a primary transfer roller 14 is disposed abutting the inner periphery of the intermediate transfer belt 17. At the position of the primary transfer roller 14, each toner image formed on the drum photoconductor 11 is sequentially transferred and overlapped onto the intermediate transfer belt 17 (primary transfer process).

Thereafter, the surface of the drum photoconductor 11 after the primary transfer process separately reaches the position opposing the cleaning device 15. The cleaning device 15 retrieves untransferred toner remaining on the drum photoconductor 11 (cleaning process).

Thereafter, the surface of the drum photoconductor 11 sequentially passes through a lubricant supply device 16 and the position of a quenching unit to complete a series of image forming process of the drum photoconductor 11.

The surface of the intermediate transfer belt 17 onto which the image of each color on the drum photoconductor 11 is transferred and overlapped moves along the direction indicated by an arrow in the drawing and reaches the position of the secondary transfer roller 18. At the position of a secondary transfer roller 18, the full color image on the intermediate transfer belt 17 is secondarily transferred to the sheet P (secondary transfer process).

Thereafter, the surface of the intermediate transfer belt 17 reaches the position of an intermediate transfer belt cleaning device. Thereafter, the intermediate transfer belt cleaning device retrieves untransferred toner on the intermediate transfer belt 17 to complete a series of the transfer process on the intermediate transfer belt 17.

The sheet P conveyed to the position of the secondary transfer roller 18 is conveyed from the sheet feeder unit 7 via a conveying guide, registration rollers 19, etc.

More specifically, the sheet P fed from the sheet feeder unit 7 accommodating the sheet P by a feeding roller 8 passes through the conveying guide and is guided to the registration rollers 19. The sheet P that has reached the registration rollers 19 is conveyed to the position of the secondary transfer roller 18 in synchronization with the toner image on the intermediate transfer belt 17.

Thereafter, the sheet P to which the full color image is transferred is guided to the fixing device 20. The full color image is fixed on the sheet P at the nip between the fixing roller and the pressure roller of the fixing device 20.

After the fixing process, ejection rollers 29 eject the sheet P as an output image outside the image forming apparatus. The sheet P is stacked on an ejection sheet unit 5 to complete a series of the image forming process.

Next, the image forming unit of the image forming apparatus 1 is described in detail with reference to FIG. 2.

FIG. 2 is a diagram illustrating the configuration of the process cartridge 10Bk for black. The process cartridge 10Bk for black is the same as the process cartridges 10Y, 10M, and 10C for color except that the color of the toner for use in the image forming process. Therefore, illustration and description of the process cartridges 10Y, 10M, and 10C are omitted.

As illustrated in FIG. 2, the process cartridge 10Bk integrally accommodates the drum photoconductor 11 as image bearer, the charging roller 12 (charging device) to charge the drum photoconductor 11, the developing device 13 to develop a latent electrostatic image formed on the drum photoconductor 11, a cleaning device 15 to retrieve untransferred toner on the drum photoconductor 11, and the lubricant supply device 16 to supply a lubricant onto the drum photoconductor 11 in a housing.

The drum photoconductor 11 as the image bearer is a negatively-charged organic photoconductor including a drum-shaped electroconductive substrate and a photosensitive layer, etc. thereon.

The drum photoconductor 11 includes an undercoating layer as an insulation layer, a charge generating layer and a charge transport layer as photosensitive layers, and a protection layer (surface layer) sequentially formed on the electroconductive substrate as the base layer.

The charging roller 12 as the charging device is a roller having an electroconductive cored bar covered with an elastic layer having a moderate resistance and is disposed downstream of the lubricant supply device 16 in the rotation direction of the drum photoconductor 11. The charging roller 12 is disposed abutting the drum photoconductor 11.

A power source unit applies a predetermined bias to the charging roller 12 to uniformly charge the surface of the drum photoconductor 11 facing the charging roller 12.

The developing device 13 includes the developing roller 13a facing the drum photoconductor 11, a primary conveying screw 13b1 facing the developing roller 13a, a secondary conveying screw 13b2 facing the primary conveying screw 13b1 via a separator, and a doctor blade 13c facing the developing roller 13a. The developing roller 13a includes a magnet fixed inside, forming a magnetic pole on the periphery of the roller, and a sleeve rotating around the magnet.

The magnet forms multiple magnetic poles on the developing roller 13a (sleeve) so that a developing agent is borne on the developing roller 13a.

The developing device 13 accommodates a two-component developing agent containing carrier and toner.

The cleaning device 15 is disposed upstream of the lubricant supply device 16 in the rotation direction of the drum photoconductor 11. The cleaning device 15 includes a cleaning blade 15a abutting the drum photoconductor 11 and a conveyor coil 15b to convey toner retrieved in the cleaning device 15 as waste toner toward a waste toner collecting container.

The cleaning blade 15a as the blade is made of urethane rubber and abuts the surface of the drum photoconductor 11 with a predetermined angle and pressure. The cleaning blade 15a mechanically scrapes objects such as untransferred toner adhering to the drum photoconductor 11 to retrieve the objects into the cleaning device 15. In addition to the untransferred toner, such objects include, for example, paper dust produced from the sheet P, corona products on the drum photoconductor 11 at the time of discharging by the charging roller 12, and additives added to the toner.

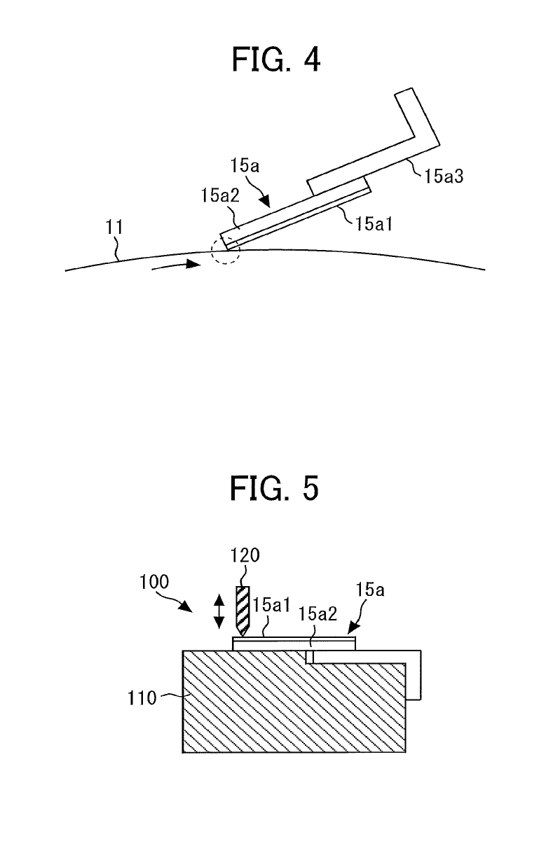

The cleaning blade 15a is described in detail later with reference to FIG. 4.

The lubricant supply device 16 includes a lubricant supply roller 16a (lubricant supply rotary member), a solid lubricant 16b, a pressure assembly of a rotary member 16g (16g1 and 16g2) and a tension spring 16h, and a layer regulating blade 16d. The layer regulating blade 16d abuts the drum photoconductor 11 in the counter direction at the position on the downstream side of the lubricant supply roller 16a in the rotation direction of the drum photoconductor 11.

The lubricant supply device 16 supplies (applies) a lubricant having a regulated (thin-layered) thickness to the surface of the drum photoconductor 11. The configuration and the behavior of the lubricant supply device 16 are described in detail later.

The image forming process described above is more detailed with reference to FIG. 2.

The developing roller 13a rotates in the direction (counterclockwise direction) indicated by an arrow in FIG. 2. The developer in the developing device 13 circulates in the longitudinal direction (vertical direction to the plane of FIG. 2) while being stirred and mixed together with toner replenished from the toner container 28 by the toner replenishing device in accordance with the rotation of the primary conveying screw 13b1 and the secondary conveying screw 13b2 disposed adjacent to each other via the separator.

The toner is triboelectrically charged and adheres to carrier. Both the toner and the carrier are borne on the developing roller 13a. Thereafter, the developer borne on the developing roller 13a reaches the position of the doctor blade 13c. The developer on the developing roller 13a is adjusted to a suitable amount at the position of the doctor blade 13c and reaches the position (development area) facing the drum photoconductor 11.

Thereafter, in the development area, the toner in the developer attaches to a latent electrostatic image formed on the surface of the drum photoconductor 11. More specifically, the toner is attached to the latent image (the toner image is formed) by an electric field generated by the voltage difference (development potential) between the latent image voltage (irradiation voltage) of the image portion irradiated with the laser beam L and the development bias applied by the development roller 13a.

Thereafter, most of the toner attached to the drum photoconductor 11 in the development process is transferred to the intermediate transfer belt 17. The untransferred toner remaining on the drum photoconductor 11 is retrieved in the cleaning device 15 by the cleaning blade 15a.

Refresh toner in the toner container 28 is suitably replenished through the toner replenishment opening into the developing device 13 in accordance with consumption of the toner already present in the developing device 13. A magnetic sensor disposed below the secondary conveying screw 13b2 in the developing device 13 detects the degree of consumption of the toner in the developing device 13.

Next, the configuration and the behavior of the lubricant supply device (lubricant supply unit) 16 is described in detail below.

As illustrated in FIGS. 2 and 3, the lubricant supply device 16 includes the solid lubricant 16b, the lubricant supply roller 16a including a foam layer therearound which slidably abrades the drum photoconductor 11 and the solid lubricant 16b, a holding member 16c to hold the solid lubricant 16b, a housing 16f to accommodate the holding member 16c together with the solid lubricant 16b, the pressure assembly of the rotary member 16g and the tension spring 16h to bias the solid lubricant 16b and the holding member 16c toward the lubricant supply roller 16a, and the layer regulating blade 16d to thin the layer of the lubricant supplied onto the drum photoconductor 11 by the lubricant supply roller 16a. The holding member 16c is a plate processed to have a U-shape and multiple holes 16c2 are formed on both sides to hold the rotary member 16g via a bearing 16j.

The housing 16f has a substantially box-like form to accommodate the holding member 16c and the solid lubricant 16b in such a manner that the solid lubricant 16b can move in the direction of pressing the lubricant supply roller 16a (in order not to prevent movement). In the housing 16f, the gap to the solid lubricant 16b and the holding member 16c is set relatively small in the range in which the movement of the solid lubricant 16b and the holding member 16c along the pressing direction (the direction in which the solid lubricant 16b is pressed against the lubricant supply roller 16a) is not prevented. Due to this setting, the solid lubricant 16b is prevented from being slantly pressed against the lubricant supply roller 16a in some degree.

The lubricant supply roller 16a includes a cored bar having a foam elastic (sponge) layer (for example, made of foam polyurethane, etc.) thereon.

The foam elastic layer is an open-cell type and formed of multiple bubbles (cells). Using an open-cell type foam elastic layer, the foam elastic layer is free of compressive residual strain and deformation for a long use period of time, which makes it possible to evenly apply a minute amount of lubricant to the surface of the drum photoconductor 11. In this embodiment, the foam elastic layer is set to have an average cell diameter of from about 400 to about 850 μm. When the average cell diameter is 400 μm or more, lubricant is easily scraped. When it is 850 μm or less, lubricant can be evenly supplied to the drum photoconductor 11.

The lubricant supply roller 16a is rotationally driven in FIG. 2 by a drive motor to abut the drum photoconductor 11 that rotates clockwise in FIG. 2 in the counter direction. In addition, the lubricant supply roller 16a is disposed to slidably abut the solid lubricant 16b and the drum photoconductor 11. The lubricant supply roller 16a rotates scraping the lubricant from the solid lubricant 16b. The scraped lubricant is conveyed to the slidably abutting position with the drum photoconductor 11 and applied (supplied) to the drum photoconductor 11.

The pressure assembly of 16c, 16g, 16h, and 16j is disposed at the rear end of the solid lubricant 16b to reduce uneven contact between the lubricant supply roller 16a and the solid lubricant 16b and presses (biases) the solid lubricant 16b held at or attached to the holding member 16c toward the lubricant supply roller 16a.

The pressure assembly includes the holding member 16c, a pair of the rotary members 16g the holding member 16c supports rotatable, a tension spring 16h (biasing member) coupled with the pair of the rotary members 16g, and a bearing 16j (FIG. 3). The solid lubricant 16b is attached to and held by the holding member 16c. The holding member 16c supports the pair of the rotary members 16g rotatable at a position distant in the width direction (vertical direction for the plane of FIG. 2). The pair of the rotary members 16g separately rotates by the biasing force of the tension spring 16h to indirectly press the solid lubricant 16b via the holding member 16c, thereby pressing the solid lubricant 16b against the lubricant supply roller 16a.

The solid lubricant 16b contains an inorganic lubricant and alumina in an aliphatic acid metal salt. The aliphatic acid metal salt preferably contains at least zinc stearate. As the inorganic lubricant, at least one of talc, mica, and boron nitride is preferably used to enhance lubricity.

In particular, properties of boron nitride are not affected by discharging. Therefore, the solid lubricant 16b mixed with boron nitride is not degraded by discharging after the charging and the transfer process on the drum photoconductor 11. In addition, the solid lubricant 16b mixed with boron nitride prevents oxidation and evaporation of the drum photoconductor 11 ascribable to discharging.

In addition, if a lubricant solely made of boron nitride is used, the lubricant supplied to the surface of the drum photoconductor 11 is not applied to all over the surface of the drum photoconductor 11 so that the lubricant film may not be uniformly formed all over the surface. Therefore, aliphatic acid metal salt is also mixed in the solid lubricant 16b in addition to boron nitride. Inclusion of this aliphatic acid metal salt makes it possible to efficiently form film of the lubricant all over the surface of the drum photoconductor 11, thereby maintaining good lubricity for a long period of time.

Specific examples of aliphatic metal salt include, but are not limited to, aliphatic acid metal salts having a lamellar crystal structure such as zinc stearate, calcium stearate, zinc laurate, barium stearate, aluminum stearate, magnesium stearate, fluorochemical resins. Also, it is possible to use material such as lauroyl lysine, monocetyl phosphoric acid ester sodium zinc salt, and lauroyl taurine calcium. In particular, if at least one of zinc stearate, calcium stearate, and zinc laurate is used as the aliphatic acid metal salt, the effect mentioned above is significantly demonstrated. Moreover, if zinc stearate is used as an aliphatic acid metal salt, extensibility on the drum photoconductor 11 is enhanced and moisture absorbency of the lubricant is low so that lubricity is not easily lost at changes of humidity.

As the material to be mixed with the solid lubricant 16b, liquid material and gas material such as silicone oil, fluorochemical oil, natural wax can be used as external additives in addition to the aliphatic acid metal salts and boron nitride.

The solid lubricant 16b having such compositions can be obtained by: loading a powdery lubricant in a die to form a solid bar under a pressure in the die; or casting a heated and melted powdery lubricant into a die followed by cooling down to form a block lubricant. In addition, a binder can be added to the composition for molding when solidifying the composition of a lubricant in a bar-like form.

When the solid lubricant 16b is applied to the surface of the drum photoconductor 11 via the lubricant supply roller 16a, the powdery lubricant is applied to the surface of the drum photoconductor 11. In this form, lubricity is not fully demonstrated. Therefore, the layer regulating blade 16d serves as a member to uniform the lubricant. Due to the layer regulating blade 16d, the lubricant forms film on the drum photoconductor 11, thereby fully demonstrating its lubricity.

If the powdery lubricant to be applied by the lubricant supply roller 16a is minute powder, the layer regulating blade 16d thins the thickness of the lubricant layer to a molecule size level on the drum photoconductor 11.

Below is the detailed description of the configuration and behavior of the image forming apparatus 1 (process cartridge 10Bk).

As described above with reference to FIG. 2, etc., the image forming apparatus 1 (process cartridge 10Bk) includes the cleaning blade 15a as the blade.

The cleaning blade 15a is made of elastic material (rubber material). The leading end (i.e., the ridge portion of the leading end enclosed by a dotted line in FIG. 3) has a substantially square plate-like form abutting the surface of the drum photoconductor 11. The cleaning blade 15a is supported at one end by a holder 15a3 made of metal material, abutting the drum photoconductor 1 in the counter direction. The cleaning blade 15a having such a configuration removes objects adhering to the surface of the drum photoconductor (image bearer) 11.

In addition, the cleaning blade 15a includes laminate layers made of rubber at least each of which is made of different material or has different hardness from each other.

More specifically, for example, the cleaning blade 15a has a two-layer structure including an edge layer 15a1 including an edge portion abutting the drum photoconductor 11 and a backup layer 15a2 formed at the position facing the drum photoconductor 11 via the edge layer 15a1. The thickness of the edge layer 15a1 and the thickness of the backup layer 15a2 are respectively set to be 0.5 mm and 1.5 mm. The edge layer 15a1 and the backup layer 15a2 are made of different material and have different hardness. This two-layered cleaning blade 15a can be formed by sequentially overlapping each layer utilizing centrifugal molding.

The cleaning blade 15a is formed to have a leading end (the portion abutting the drum photoconductor 11 and the near portion thereof) having an elasticity power of from 65 to 93 percent.

Elasticity power means a value obtained by calculating elastic workload based on the relation between stress applied to a member and displacement of the member caused by the stress and dividing the elastic workload by the entire workload (elastic work and plastic work).

More specifically, elasticity power is obtained as follows:

The cleaning blade 15a is set in a fixing jig 110 of a measuring instrument 100 illustrated in FIG. 5. A cumulated stress W1 when a Vickers indenter 120 is pressed in the cleaning blade 15a and a cumulated stress W0 at the time of releasing the test load are measured. The measuring results are assigned to the relation W0/W1×100 percent to obtain the elasticity power. As elasticity power increases, the ratio of elasticity power increases and hysteresis loss (plastic deformation) decreases, meaning rubber property increases. As elasticity power decreases, the ratio of plastic work increases and elastic deformation decreases. In such a case, the article is close to glass rather than rubber.

The measuring instrument 100 is microhardness tester (HM2000, manufactured by Helmut Fischer GmbH). Elasticity power is measured at 23 degrees C. and relative humidity of 50 percent under conditions of a press-in load of 1 N, a pressing time of 10 seconds, and a creeping time of 5 seconds. When the Vickers indenter 120 is pressed at the time of measuring, Vickers indenter 120 bites the cleaning blade 15a in an amount of about 5 to about 10 μm. For the measuring, the cleaning blade 15a is set at the fixing jig 110 with the upper surface of the edge layer 15a1 horizontal and the Vickers indenter 120 is pressed into the cleaning blade 15a at the position 20 μm from the leading end ridge portion of the edge layer 15a1. The biting amount of the Vickers indenter 120 is sufficiently small in comparison with the thickness (0.5 mm) of the edge layer 15a1. Therefore, properties of the portion around the leading end ridge portion of the edge layer 15a1 having a correlation with cleanability and abrasion can be measured without an impact by the backup layer 15a2.

Unlike hardness and impact resilience used in general as characteristic values of rubber, the thus-obtained elasticity power indicates local responsiveness of a blade. Therefore, elasticity power is effective as a characteristic value affecting the behavior of the leading end (the portion abutting the drum photoconductor 11).

In this embodiment, elasticity power of the leading end (abutting portion) of the cleaning blade 15a is optimized. Therefore, drawbacks such that lubricant is excessively or unevenly supplied (applied) to the surface of the drum photoconductor 11 do not easily occur over time. Therefore, drawbacks such that the working life of the lubricant supply device 16 (solid lubricant 16b) is shortened or defective images having vertical streaks are produced due to uneven supply of the lubricant do not easily occur.

More specifically, in the range of an elasticity power of the leading end of the cleaning blade 15a of 93 percent or less, rubber property of the leading end of the cleaning blade 15a is prevented to be excessively high, and repetition of elongation and contraction, referred to as stick slip, of the elastic part of the leading end of the blade caused by abrasion between the drum photoconductor 11 and the cleaning blade 15a can be reduced. Therefore, the drawback is reduced such that the lubricant on the drum photoconductor 11 is excessively removed and an excessive amount of the lubricant is supplied for complementation from the lubricant supply device 16 to the surface of the drum photoconductor 11. That is, the amount of the lubricant supplied (applied) to the drum photoconductor 11 is stabilized over time.

In addition, in the range of an elasticity power of the leading end of the cleaning blade 15a of 65 percent or more, rubber property of the leading end of the cleaning blade 15a is prevented from being excessively low so that the leading end of the blade is not easily abraded or chipped off locally. Therefore, attachability between the drum photoconductor 11 and the leading end of the cleaning blade 15a is suitably secured over time, which reduces occurrence of a drawback such that the lubricant on the drum photoconductor 11 non-uniformly slips through at the position of the cleaning blade 15a. That is, the drawback of uneven supply (application) of the lubricant to the surface of the drum photoconductor 11 is reduced.

The aliphatic acid metal salt contained in the lubricant supplied to the drum photoconductor 11 in this embodiment tends to cause the lubricant to lose lubricity due to discharging in the charging process. Therefore, in the present embodiment, an inorganic lubricant such as boron nitride is added to the lubricant to prevent such degradation of the lubricant. Therefore, this also reduces sliding abrasion between the cleaning blade 15a and the drum photoconductor 11.

Below is the description about the experiments conducted by the present inventors to check the effects described above.

For these experiments, ten kinds of the cleaning blades 15a having different elasticity power for the leading ends of Examples 1 to 7 and Comparative Examples 1 to 3 are prepared. Respective cleaning blades 15a are subject to an endurance test for sheet feeding in a real machine to evaluate consumption rate of lubricant, uneven application (supply) of lubricant, and abrasion area of leading end.

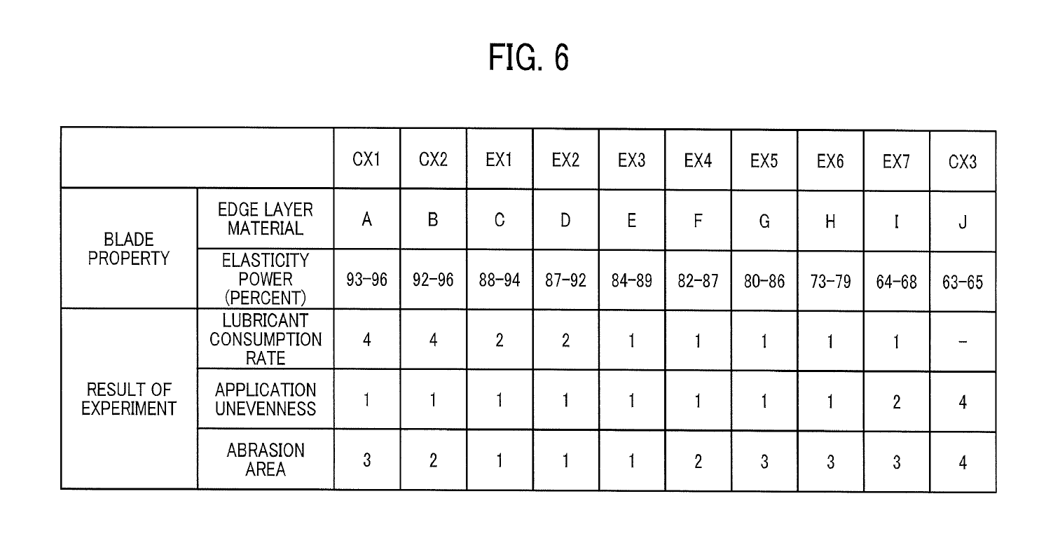

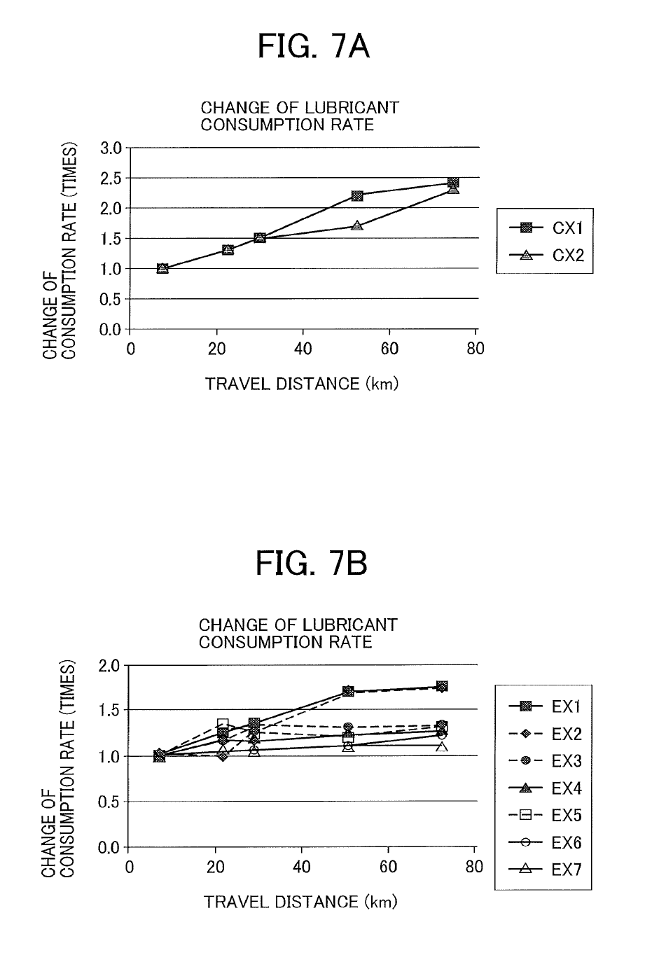

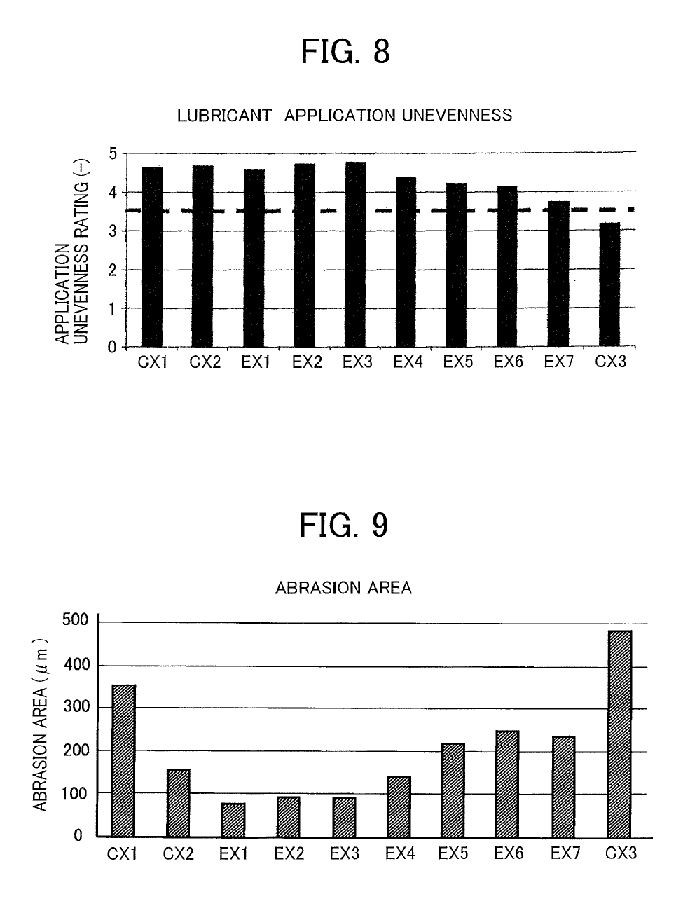

FIG. 6 is a table illustrating blade properties and experiment results of the cleaning blades 15a of Examples 1 to 7 and Comparative Examples 1 to 3. In Table 7, the edge layer material is urethane rubber. FIGS. 7A and 7B are graphs illustrating relations between the traveling distance of the drum photoconductor 11 and the consumption rate of the lubricant of Examples 1 to 7 and Comparative Examples 1 to 3. FIG. 8 is a graph illustrating the rating of uneven application of the lubricant of Examples 1 to 7 and Comparative Examples 1 to 3. FIG. 9 is a graph illustrating the abrasion area of the leading end of the cleaning blade 15a of Examples 1 to 7 and Comparative Examples 1 to 3.

In the experiments (Examples 1 to 7 and Comparative Examples 1 to 3), the backup layers 15a2 of the cleaning blade 15a are made of the same material (composition) and have the same thickness. Due to the change made to the material of the edge layer 15a1 with the same thickness, the elasticity power of the cleaning blade 15a is changed as illustrated in FIG. 6.

The endurance test for sheet feeding is printing an image having an image area of 5 percent on 4 sheets per job (4P/J) with a run length of from 140,000 to 160,000 sheets. In the graphs of FIGS. 7A and 7B, the consumption rate of the lubricant is adjusted to be about 200 mg/km from the start of the test until the travel distance of the drum photoconductor 11 reaches 7.5 km, which is used as the reference. The change (multiplying times) thereafter is plotted as the change (times) of the consumption rate of the lubricant.

If the consumption rate is too low, lubricity lowers so that the cleaning blade 15a tends to screech and filming easily occurs to the drum photoconductor 11. Conversely, when the consumption rate is excessively high, the charging roller 12 is easily contaminated or the amount of the lubricant tends to be short. Therefore, the consumption rate of the lubricant is preferably in the range of from about 150 to about 400 mg/km. Therefore, if the average initial consumption rate is 200 mg/km, the consumption rate (times) is preferably within twice.

As illustrated in FIG. 7A, the consumption rate of the lubricant increases over time in Comparative Examples 1 and 2 and surpasses twice at the time of a travel distance of 50 km. That is, when the elasticity power of the leading end of the blade surpasses 93 percent, the consumption rate mentioned above surpasses the upper limit of the 400 mg/km.

Conversely, as illustrated in FIG. 7B, in Examples 1 to 7, the elasticity rate of the leading end of the blade is 93 percent or less, and the consumption rate is stable and changes little from the start. Since the change of the consumption rate is from about 1.1 to about 1.8 times, the consumption rate of the lubricant is within the range of from 150 to 400 mg/km over time. In particular, in Examples 3 and 7 in which the elasticity power of the leading end of the blade is less than 90 percent, the change of the consumption rate is from about 1.1 to about 1.3 times, and is extremely stable.

In addition, in the endurance test of sheet feeding, uneven application of lubricant was evaluated when the travel distance of the drum reached 75 km. The evaluation was made in such a manner that images of the surface of the drum photoconductor 11 downstream of the layer regulating blade 16d were taken by microscope VHX-199 (objective lens, 200×) to take in the image. Uneven application causes defective images having vertical streaks along the rotation direction of the drum photoconductor 11. These vertical streaks were digitized from dispersion values of brightness as unevenness of brightness of images and rated, which is the result shown in FIG. 8.

The uneven application of lubricant may be recognized as a vertical streak in a half tone image if rated below 4 and is intolerable if rated below 3.5. As illustrated in FIG. 8, Examples 1 to 7 and Comparative Examples 1 and 2 are rated as 3.5 or greater for the uneven application. For Comparative Example 3, the rate was below 3.5, which is 3.2. Namely, unless the elasticity power of the leading end of the blade is 65 percent or higher, intolerable uneven application (supply) of lubricant occurs to the surface of the drum photoconductor 11.

As seen in the experiment results shown in FIG. 6, the consumption rate of a lubricant can be stabilized over time for the leading end of the cleaning blade 15a formed to have an elasticity power of 93 percent or less. In addition, for the cleaning blade 15a formed to have an elasticity power of 65 percent or greater, uneven application (supply) of lubricant can be reduced over time. That is, for the cleaning blade 15a formed to have an elasticity power of from 65 to 93 percent, a lubricant can be stably applied (supplied) to the drum photoconductor 11 over a long period of time.

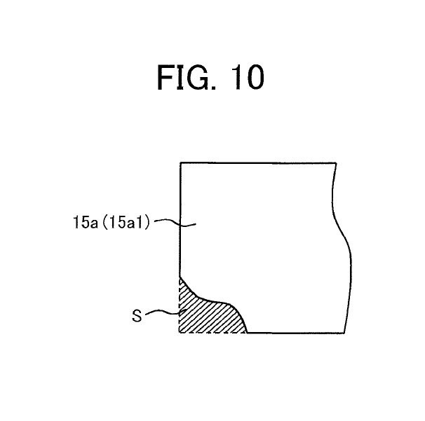

In addition, in the endurance test of sheet feeding, abrasion area of the leading end (blade front portion) of the cleaning blade 15a was evaluated (measured) when the travel distance of the drum reached 75 km. The evaluation was made in such a manner that the solid image of the leading end of the blade was observed with a laser microscope (VK-9500, manufactured by KEYENCE CORPORATION) to obtain the abrasion area S of the leading end of the blade (FIG. 10). Each of the abrasion blade area S of Examples 1 to 7 and Comparative Examples 1 to 3 is shown graphically (FIG. 9).

As illustrated in FIG. 9, of Examples 1 and 7 in which the consumption rate of a lubricant is good and uneven application is less, Examples 1 and 4 are found to be less abraded.

In Comparative Example 1, the elasticity power is high and friction force caused by degraded lubricant tends to cause stick slip of the leading end of the blade. Therefore, the abrasion area of the leading end of the blade increases.

Also, in Comparative Example 3, the elasticity power is low so that degraded lubricant scratches the leading end of the blade, which tends to cause local abrasion and chipping-off. As a result, the leading end of the blade is unevenly abraded depending on the position in the width direction. Due to a continuous use of the cleaning blade in such a state, local abraded portions gather and form a large block, which further and entirely accelerates abrasion of the blade.

As seen in these results, to reduce the abrasion speed of the leading end of the blade, a particular range of the elasticity power is found to be necessary.

More specifically, as seen in the experiment results illustrated in FIG. 6, if the cleaning blade 15a having an elasticity power of the leading end of from 83 to 93 percent is formed, a lubricant is stably supplied to the drum photoconductor 11 over a long period of time. Also, abrasion of the leading end of the cleaning blade 15a is delayed, thereby elongating the working life of the cleaning blade 15a.

As described above, the process cartridge 10Bk (image forming apparatus 1) includes the lubricant supply device 16 to supply a lubricant to the surface of the drum photoconductor 11 (image bearer) 11 and the cleaning blade 15a having an leading end abutting the surface of the drum photoconductor 11. The cleaning blade 15a is formed to have an elasticity power of the leading end of from 65 to 93 percent.

According to this, it is possible to reduce occurrence of drawbacks of excessively or unevenly supplying a lubricant to the surface of the drum photoconductor 11.

In this embodiment, each member (drum photoconductor 11, charging roller 12, the developing device 13, the cleaning device 15, and the lubricant supply device 16) in the image forming unit is integrated to form the process cartridges 10Y, 10M, 10C, and 10Bk to improve the size reduction of the image forming unit and maintenance performance.

Conversely, it is possible to have a configuration in which each member 11, 12, 13, 15, and 16 in the image forming unit does not form a process cartridge but can be separately and replaceably set in the image forming apparatus 1. In such a configuration, the same effect of the present embodiment can be obtained.

In the present disclosure, process cartridge is defined as a unit which integrally includes an image bearer and at least one of a charging device to charge the image bearer, a developing device to develop a latent image formed on the image bearer, and a cleaning device to clean the surface of the image bearer and is detachably attachable to an image forming apparatus.

In the present embodiment, the present disclosure is applied to a tandem color image forming apparatus using the intermediate transfer belt 17. Also, the present disclosure is applicable to a tandem color image forming apparatus using a transfer conveyor belt (toner images on multiple drum photoconductors disposed in parallel facing the transfer conveyor belt), monochrome image forming apparatuses, or other image forming apparatuses. In such a configuration, the same effect of the present embodiment can be obtained.

In the present embodiment, the present disclosure is applied to the cleaning blade 15a abutting the drum photoconductor 11 as an image bearer. However, it is naturally applicable to a blade abutting an image bearer other than the drum photoconductor 11, for example, the intermediate transfer belt 17, to which a lubricant supply device to supply a lubricant is set.

In the present embodiment, as the pressure assembly to bias the solid lubricant 16b toward the lubricant supply roller 16a, an assembly including a pair of rotary members 16g (16g1), the tension spring 16h, etc. is used. However, the pressure assembly is not limited thereto. For example, a pressure assembly is usable which includes a compression spring installed on both ends along the rotation direction.

In the present embodiment, a sponge roller including a cored bar covered with a foam elastic layer is used as the lubricant supply roller 16a. Conversely, a brush roller can be also usable which includes a cored bar covered with brush as a lubricant supply roller.

In such a configuration, the same effect of the present embodiment can be obtained.

According to the present disclosure, provided are a process cartridge and an image forming apparatus which reduces occurrence of drawbacks of excessively or unevenly supplying a lubricant to the surface of an image bearer.

The present disclosure is not limited to the embodiments described above. In the scope of the technology ideas of the present disclosure, it is obvious that embodiments of the present disclosure can b suitably applicable other than the embodiments described above. In addition, the present disclosure is not limited to the number, position, forms, etc. of the embodiments described above and those can be suitably selected to suit to enforcement of the present disclosure.

Having now fully described embodiments of the present invention, it will be apparent to one of ordinary skill in the art that many changes and modifications can be made thereto without departing from the spirit and scope of embodiments of the invention as set forth herein.

What is claimed is:

1. A process cartridge comprising:
an image bearer configured to bear a toner image;
a lubricant supply device configured to supply a lubricant to a surface of the image bearer; and
a blade made of elastic material, with a leading end abutting the surface of the image bearer,
wherein the leading end is formed to have an elasticity power of from 65 to 93 percent,
wherein the process cartridge is detachably attachable to an image forming apparatus.

2. The process cartridge according to claim 1,
wherein the elasticity power is from 83 to 93 percent.

3. The process cartridge according to claim 1,
wherein the lubricant comprises an aliphatic acid metal salt and an inorganic lubricant.

4. The process cartridge according to claim 3,
wherein the aliphatic acid metal salt comprises at least one of zinc stearate, calcium stearate, and zinc laurate,
wherein the inorganic lubricant comprises at least one of mica, talc, and boron nitride.

5. The process cartridge according to claim 1,
wherein the blade is a cleaning blade having a substantially square plate-like form configured to remove an object adhering to the surface of the image bearer,
wherein the blade is supported at one end by a holder made of metal material and abuts the image bearer in a counter direction.

6. The process cartridge according to claim 5,
wherein the cleaning blade is formed of laminated layers each of which is made of rubber having either or both of a different composition and a different hardness.

7. An image forming apparatus comprising:
the process cartridge of claim 1.
